(19) United States
(12) Patent Application Publication
(10) Pub. No.: US 2005/0246705 A1
(43) Pub. Date: Nov. 3, 2005

(54) Method for dynamically allocating and managing resources in a computerized system having multiple consumers

(75) Inventors: Garik Etelson, Kiryat Ono (IL); Gregory Bondar, Rishon Lezion (IL); Michael Stoler, Yahud (IL)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: SPHERA CORPORATION, NEWTON, MA (US)

(21) Appl. No.: 11/042,478

(22) Filed: Jan. 25, 2005

Related U.S. Application Data
(63) Continuation of application No. PCT/IL03/00619, filed on Jul. 25, 2003.

(30) Foreign Application Priority Data
Jul. 25, 2002 (IL) 150911

(51) Int. Cl. G06F 9/46

(52) U.S. Cl. 718/100

(57) ABSTRACT

Method for dynamically allocating and managing resources in a computerized system managed by an operating system (OS) and having multiple accounts of consumers. Portions of the virtual memory address space are allocated, whenever desired, in a swap file, for each account associated with a consumer. The memory address space is limited for each account. The CPU usage is divided between the tasks requested from each account, and segments in the original code of the OS are changed by locating one or more specific procedures in the original code, and modifying the specific procedures to operate according to the allocation and/or the limitation of the memory address space and/or the limitation of the number of processes and/or the divided CPU usage.

### RELATED APPLICATION

This application is a continuation of International Patent Application Serial number PCT/IL2003/000619 filed Jul. 25, 2003, the contents of which are here incorporated by reference in their entirety. The benefit of 35 USC Section 120 is here claimed.

### BACKGROUND OF THE INVENTION

1. Field of the Invention

The present invention relates to the field of managing a computerized system. More particularly, the invention relates to a method for limiting the resources that are used by consumers, systems and web services of a given computerized system.

2. Prior Art

Hosting a Website locally is relatively expensive, as it requires allocating sufficient bandwidth for Internet traffic to the site, as well as allocating resources for keeping the site available all the time (both in terms of software and hardware) and handling security aspects, such as a firewall.

Web Hosting Providers (WHP), which are the consumers of a computerized system, use a variety of service models to address different types of customers, depending on the required class of service. The Web sites of small and medium-sized businesses normally do not preempt the resources afforded by a dedicated server, and therefore might settle for a shared server model. However, as the requirements of the WHP change and their sites conduct more and more activity, they become more resource-consuming. When WHPs become more resource consuming, they usually, hire more resources, or keep the same resources with decreased performance. As the demand for the site's services is not constant over a time period, the customer might prefer to keep the same resources rather than hiring more resources, assuming that a relatively high demand for resources might occur for only a relatively short duration.

Typically, each dedicated server runs an instance of the OS (Operation System). However, running an instance of the OS for each dedicated server comparatively requires a large amount of resources, which is required for each instance of the OS.

Hereinafter, the term “computerized system” refers to a server that hosts a plurality of virtual dedicated servers that execute a plurality of services, wherein each virtual dedicated server utilizes a substantial portion of the computer resources.

A virtual dedicated server in such a computerized system is actually an emulation of a computer system's interface in which a remote client can access its system utilities and programs, and it will be called hereinafter a Virtual Dedicated Server (VDS). A plurality of VDS instances can be executed simultaneously on a single hosting computerized system.

The term “account” refers to a certain part of the machine's resources that is allocated to a specific user. An account might share its allocated resource with other accounts, but together they can not utilize more than their allocated share. An “account” can be allocated to a user, a domain, a VDS, a service, a specific processes or process groups or to any other suitable user of the machine's resources.

One of the existing solutions for limiting the resources consumption of an account is to use a static division of the computer resources. The hosting computer resources are divided in a static manner between the virtual computers. The result is that if, for example, the real computer is split into 10 identical virtual computers, then 10% of the system resources are allocated to each virtual computer, even if only one virtual computer is being operated. A dynamic resource allocation would result in a better performance per virtual computer (if not all the VDSs are activated at the same time), with an appropriate allocation to each VDS (according to predefined parameters) in the case that a plurality of VDSS are activated at the same time. Therefore, the dynamic resource allocation results in a better performance from the user's point of view. The dynamic resource allocation can be used by any consumer of the computer resources, such as different services, different users, etc.

Resources of a computerized system are limited due to several factors such as budget, spatial restrictions, etc. Resources of a computerized system comprise, among others, the usage of a Central Processing Unit (CPU), the size of a memory address space, storage capabilities of data, etc. A computerized system used by multiple consumers, whether they are WHP or regular consumers, needs to provide to each of its consumers, at least, a predefined percentage of its resources according to predefined terms or agreements between each consumer and the corresponding resources owner in the computerized system. a WHP may offer more than the actual available resources, based on the low probability that all consumers will concurrently demand maximum resources Therefore, in order to enable different consumers to have their predefined share of resources, there is a need to limit the resources available to a specific consumer according to those predefined for him. Additional reasons for limiting the resources consumption for each consumer in a multiple consumer computerized system may be as follows:

If the resources are not of a preempt kind (i.e., non-preemptable), then a suitable process in the computerized system should free those resources by itself, upon receipt of such a resource. For example, the memory or a suitable storage disk of a computerized system is usually non-preemptable. Granting a higher number of resources might prevent a process, before the previous resources were freed, from getting its share. Unfortunately, it is relatively complicated to remove the resources, once granted.

If the resources are of a preempt kind (i.e., preemptable), then in every time-slice they are divided between the requesting processes. For example, a CPU is usually a preemptable resource. When dealing with preemptable resources, there are two possibilities to deal with the unused resources, as the allocation is performed on every time-slice from scratch. The first, granting the process more than his allocated share will make the user treat such performance as his base line. However, when additional consumers connect to the computerized system and start to utilize their share of resources, then the previous consumers connected to such a system will suffer from a reduction in their total performance. The second, limiting the resources from the beginning, might prevent such a situation, but is less desirable from the end-user's point of view.

If the resources are preemptable and an owner of a computerized system wishes to charge each of his consumers differently, according to the guaranteed resources of each, the owner will accordingly wish to confine the consumer to his allocated share of resources.

There are several companies, such as “Ensim Corporation”, that create “static virtual computers” within the computer. Each “static virtual computer” is allocated a certain amount of CPU, memory etc. However, the computer's owner is not able to allow the static virtual computer to use more than its allocated share, in case other users do not use their allocated share, and therefore there are available resources.

Furthermore, in a static virtual computer, for example, if the WHPs want to allocate the computer resources to 2 different resellers (i.e., 50% for each reseller), and one of the resellers wants to supply his allocated part to 2 additional users, guaranteeing 75% (of his allocated part) for each, such hierarchical allocation can not be done. This is because 25% from the allocated resources for each user is less than the guaranteed resources, and 37.5% is too much to allow the consumers to use, as other users of the other reseller might be influenced.

In the prior art, a common method of allocating resources of a computerized system is to provide a predetermined amount of resources to each consumer. However, such a method has several drawbacks, such as in a computerized system with a relatively high number of consumers, adding a new consumer to such a system requires re-allocating the resources for all the other consumers. For example, if the owner of a computerized system wants to share its system resources “evenly” between its consumers, then, for example in the case of 10 consumers—he grants 10% of the system's resources to each (i.e., 100% of the system resources is allocated to all consumers). If, however, the owner wants to add an additional consumer to that system, he must update the allocated resources to each of the existing 10 consumers, in such a way that there will be available resources to the new added consumer. If there are numerous clients (e.g., 100, 1000 or more), this task will involve considerable time and/or might be prone to user errors while allocating all the resources for all the consumers each time there is a change of status in the system. The task of re-allocating resources increases in complexity where one or more consumers are granted more resources than the others. More complexity occurs if the owner of the computerized system has “resellers” (i.e., consumers entitled to share resources with their own consumers). Typically, a comparison is made between what the account consumes and its allocated quota. However, the software re-calculates the system resources on each operation that might utilize resources. For example, if the resource that is checked for the comparison is memory, the comparison should be performed only before memory allocations, however this is inefficient for suitable allocation due to the fact that it is only done before.

All the methods described above have not yet provided satisfactory solutions to the problem of efficiently allocating and managing resources of a computerized system with multiple consumers.

### SUMMARY OF THE INVENTION

It is an object of the present invention to provide a method for individually limiting the resources consumption of each consumer, whether it is a service or a user.

It is an object of the present invention to provide a method for better allocating the resources between the consumers.

It is still another object of the present invention to provide a method for allocating resources with a desired hierarchy.

It is a further object of the present invention to provide a method and system for calculating the allocated resources, dynamically and on demand.

It is yet an object of the present invention to provide a method and system for allowing a consumer to observe the current resource allocation.

Other objects and advantages of the invention will become apparent as the description proceeds.

The present invention is directed to a method for dynamically allocating and managing resources in a computerized system managed by an operating system (OS) and having multiple accounts of consumers. Portions of the virtual memory address space are allocated, whenever desired, in a swap file, for each account associated with a consumer. The memory address space is limited for each account. The CPU usage is divided between the tasks requested from each account, and segments in the original code of the OS are changed by locating one or more specific procedures in the original code, and modifying the specific procedures to operate according to the allocation and/or the limitation of the memory address space and/or the limitation of the number of processes and/or the divided CPU usage.

Preferably, the specific procedures are dynamically modifying to operate in response to varying allocation and/or limitation of the memory address space and/or the divided CPU usage. The location of the required procedure is allowed by obtaining the name of the required procedure that is stored in a symbol table, or by identifying a sequence of bytes of the required procedure.

In order to modify a specific procedure, the allocated memory address space is obtained and creating an executable code in the allocated memory address space. Code segments from the original code are copied, the commands line at the beginning of the copied code are saved and further commands are skipping until beginning of the next command in the original code. The commands line at the beginning of the original code is replaced by skipping to the beginning of the created application, and adding non-operational bytes to the unused bytes of the created application. The blank bytes may be No Operations (NOPs) data.

The limitation of the memory address space is implemented by calling the original code whenever the call for consuming resources is not by an account of a specific consumer, and identifying the account by its related parameters. It is verified that the account will not exceed its quota, or the quota of the level above it according to the allocated memory address space, whenever resource consumption is required by an account. The result of an operation related to the account, whenever it succeeds is checked and the consumption data of the account and/or of the levels above the account is updated. The identifying parameters may be a user ID, group ID or program name.

When limiting the number of processes it is verified that the account will not exceed its quota, or the quota of the level above it, according to the allocated number of processes, whenever resource consumption is required by an account. The result of an operation related to the account, whenever it succeeds, is checked and the consumption data of the account and/or of the levels above the account is updated. The identifying parameters may be a user ID, group ID or program name.

CPU resources that are not demanded by accounts according to their resource allocation policy are dynamically allocated to other demanding accounts and the available CPU resources are divided between all the tasks according to an optimal share allocation per each account. Division of the CPU usage between the tasks may be obtained by modifying the calculation of the “counter” of the tasks that are candidates for being executed, so that each task is limited by the quota of the account that is associated with the tasks.

The modification of the counter calculation is performed by intercepting the function that performs the calculation of the “counters”. Then, the desired “counter” value is calculated for each task, based on the guaranteed value to the user account and holding the correct value of the counter according to the quotas when its value is calculated whenever there are several tasks that belong to the same account. The “counter” value of the tasks is summed according to the account, while their internal allocation is currently performed according to their usage. Information regarding the “behavior” of each process is kept and the amount of CPU resource that the account received during the last time is calculated on every “tick”, and the calculated amount is added to the levels above the account. Whenever the account or a level above the account receives more than its allocated share, the “counter” of the task is decreased to zero, until the next CPU allocation is done. Whenever a decision is made about the next task to be executed, it is confirmed that the selection of the next task to be executed is valid.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates hierarchical allocation of resources in a computerized system with multiple consumers, according to a preferred embodiment of the invention;

FIG. 2 schematically illustrates a modification of a required procedure as part of changing the OS behavior, according to a preferred embodiment of the invention; and

FIG. 3 schematically illustrates the CPU usage by a specific account.

### DETAILED DESCRIPTION OF PREFERRED EMBODIMENTS

In order to prevent consumers from exceeding the allocated resources in a computerized system, there is a need to limit the resources, such as the memory, number of processes and the CPU usage available to each consumer from such a system.

The embodiments described hereinafter will be more apparent after clarifying the following terms:
Program—An executable file that the kernel can read to memory and execute.
Process—An executing instance of a program. Every process in Unix is guaranteed to have a unique numeric identifier called Process ID (PID).

A thread is a single sequential flow of control within a process. A process can thus have multiple concurrently executing threads. In Linux, each thread has its own PID.

In Linux OS, the function that creates processes is do_fork. The functions that handle process termination are the exit family. A simple implementation could be to keep a counter per user that the system increases/decreases according to initiation/termination of processes per account, except for processes owned by “root” (UID 0). When an account tries to initiate new process that causes it to exceed its quota, the system will fail performing the “fork” (or “vfork”, “thread_create”) function. Hierarchy semantics is the same as of the memory management.

The following describes a mechanism for limiting the memory consumption of a specific account in the computerized system. But first, for the sake of clarity, the method for allocating memory in an Operation System such as Unix, Linux, etc. will be described.

Each executed application obtains a portion of memory area, from which it runs or operates. A memory area, referred to hereinafter as “memory address space”, comprises relevant data of specific executed applications. The memory address space is only a portion of a virtual memory specific to each application. Each application has its own range of virtual memory, usually unrelated to the address space of other applications, or to the size of the physical computer on which the application is executed.

Typically, the memory is divided into “pages”, which is the basic unit handled by a memory management application. A memory manager can store the “pages” in the physical memory of the computer, or on the hard disk (in a so-called “Swap” section). The “swap” acts as a storage memory and temporarily stores data portions of the application on the hard disk, typically, when there is not enough physical memory space for all the programs. The swap can be a set of files, special disk partitions, or both. Information can be stored on the hard disk (either in the “swap” or in real files) for the following reasons:

The memory manager transfers a relatively less relevant “page” to the “swap”, to free storage space in the (faster) physical memory, for other pages that are currently required. The memory manager transfers only pages that might be changed by an application, the other pages being restored from their initial address (as will be described hereinafter).

The page is part of the writeable area of the program, but the program does not change it. In this case, the page can be loaded from the disk when next needed.

The page is part of the application “code” (i.e., the command line that the application executes, and not the data part of the application). The application code cannot be changed by the application itself, and therefore, if a page is removed from the memory, the memory manager can,retrieve it from the application file again.

The page is part of the application “read only” data. The “read only” data cannot be changed by the application itself, and therefore, if a page is removed from the memory, the memory manager can again retrieve it from the application file.

The page is part of a file of an operation system such as the “mmap”ed file in Unix. The “mmap” function maps “length” bytes starting at the offset from the file (or other object) specified by a variable that is passed to “mmap”, such as the variable file descriptor (fd), into the memory, preferably at the address of the parameter that is passed to “mmap”, such as the parameter “start”).

After the mapping, the program can access the file just like any part of its memory, without the need to actually read the information into buffers that it allocates. In that case, a file is mapped to part of the memory of an application and there is no need to keep the pages in the swap file, as they can be read from the hard disk.

According to a preferred embodiment of the invention, in order to avoid exceeding the allocated memory of a consumer's account, the allocated memory address space on the swap file of that account is limited. In contrast, the physical memory used by an application is not limited, and thus this eliminates interference with the way in which the operating system works and decides what pages to swap. In the operating systems, such as Linux™ and Unix™, the amount of memory that a program utilizes can be influenced by one or more of the following methods:

Initial allocation of memory, when the process is created;

Enlargement of memory, due to one or more requests that utilized all the memory available (e.g., the function “malloc” in Unix, which requests the OS to allocate more memory to the process. The OS might prefer to allocate more than the program requests, to handle the case where the program might request more pages later on. This is part of the memory management of the OS. The function “malloc” is standard in C and C++, and is available on Windows™ as well.)

Mapping to a file (e.g., using the “mmap” function), that maps a file to a specific memory address space.

Creating a shared memory region (e.g., using the function “shmget”, wherein “shmget” enables a program to request a certain amount of memory from the OS, and in turn it associates an identifier with that program. Other programs might use this memory as well, by using the related identifier. The function “shmget” is a mechanism for sharing information between processes.).

As will be explained hereinafter, all the above methods and other possible methods are mapped to a relatively small set of functions in the kernel of the operation system.

For example, in Linux with version of kernel 2.2 all the operations are mapped to a function in the kernel, named “do_mmap”. The “do_mmap” function gets the following parameters:

Access mode—Read/Write (RW) or Read Only (RO). If it is RO, then the memory can be accessed for read only, and in that case, no swap space is allocated, as the information can be retrieved from its place of origin. In this case, the method of the present invention does nothing.

Mapping—private or shared in the case of RW. If it is shared, only the creator of the shared storage should be charged for this memory. The term private refers to a memory that only a specific program can access, such as memory that was allocated when the specific program started running, or that was “malloc”ed. The term Shared refers to one that is shared between processes, for example, while loading a shared object (e.g., a Dynamic Link Library (DLL, which is a collection of small programs, each of which can be called when needed by a larger program that is running in the computer, in Windows2000 environment.

Of course, the “do_mmap” function is only one example of a Linux implementation, and such operation is suitable to other functions as well.

Therefore, the only situation that involves allocating swap space is when the application asks for a private memory for RW.

It is important to note that a function such as “do_mmap” returns the relevant memory addresses, but the pages are not allocated in the physical (and thus not in the swap) memory, until they are actually used. The allocation is on a page basis, so a program can allocate one hundred pages, and access only two of them (at the beginning and end of the memory, for example). In that case, only two pages are allocated in the memory, and thus can be moved into the ‘swap’.

According to a preferred embodiment of the invention, it is assumed that all the pages are used and the calculation of memory usage is performed when the page is allocated. According to another preferred embodiment of the invention, the actual consumption is checked whenever a page is used for the first time. However, this might cause a program to stop working while accessing a valid address, which does not comply with the behavior of the OS. In order to allow the program to behave normally, without being aware that it is controlled by the embodiment of the invention, the present invention complies with the OS behavior.

Interfering with the OS

In the prior art, there are several known methods for changing the behavior of an operating system, such as:

Changing the source code of the operating system. This solution is problematic, as the source code is not always available. If it is available, it must usually be maintained, and therefore, the solution of modifying the code would require updating every new version of the code that might be distributed.

Use “hooks” in a code. Typically, an OS has “hooks” that may be used. These hooks are places that the OS activates specific modules that are defined by a user, wherein the OS performs specific operations. However, “hooks” must be implemented as part of the OS, and therefore can be used only where the OS writers locate it.

According to a preferred embodiment of the invention, no code change is made. Instead, it locates a required procedure in the code of the kernel, and then modifies it into a suitable code, as will be described hereinafter.

Locating the Required Procedure

The required procedure exists in the kernel's code, and therefore locating it in the kernel can be obtained, for example, by using the name of the required procedure that is stored in a suitable symbol table. Of course, the required procedure can be located in other ways, such as, if, for example, the function is ‘not exported’, there could be a mechanism used for locating a specific sequence of bytes of that function, etc.

Modifying the Required Procedure

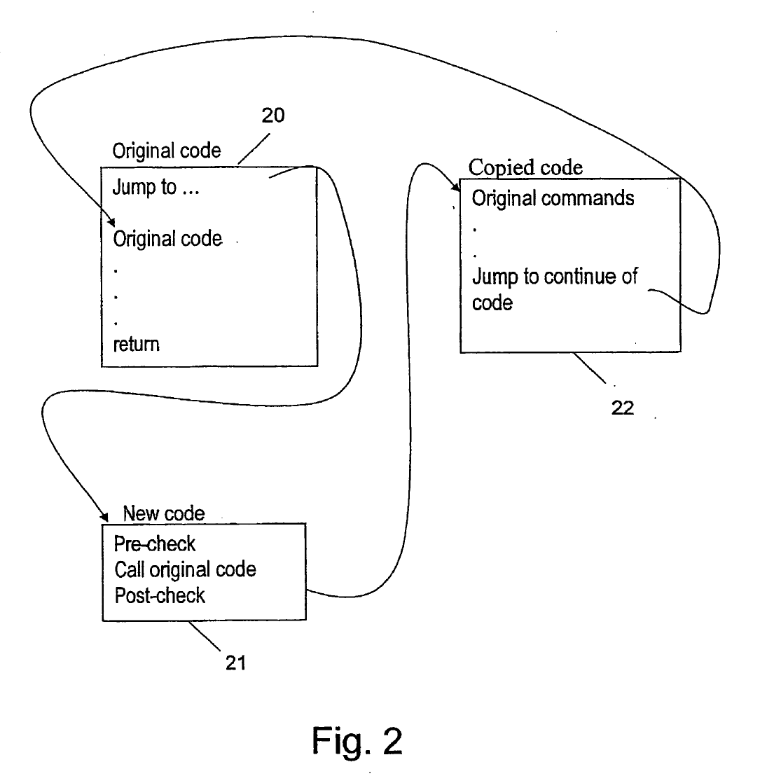

FIG. 2 schematically illustrates a modification of a required procedure, according to a preferred embodiment of the invention. Modifying the required procedure (i.e., changing an original code) is done in the following way:

Loading all the functions as will be mentioned later on, using, for example, the “insmod” program in Kernel 2.2 of Linux.

Allocating a required range of memory address space to be used by a New code 21.

In this allocated range, creating a code, which are a series of commands (i.e., New code 21), that performs the logic mentioned later.

Keeping the commands lines at the beginning of the copied code 22, and then performing a “jump” to the beginning of the next command in the Original code 20.

Replacing the commands line at the beginning of the Original code 20 with a “jump” to the beginning of the New code 21, and adding bytes with that perform no operation, such as No Operations (NOPs), until the end of the relevant command. For example, if the function starts with three commands comprising four bytes each, and the “jump” comprises six bytes, then two NOPs are added, so that jumping to the place after the “jump” will not result in performing an unintended code.

In the new code 21, one can call the original code 20 by calling the code in the copied code 22. Original code 20 performs the actual operation, which is the service of the relevant system module, such as memory allocation, CPU allocation or other suitable logic allocation by changing the program's information, parameters in the kernel, and any other activity that is required for performing the allocation. According to the preferred embodiment of the invention, original code 20 is executed separately from new code 21. The execution of original code 20 is obtained by calling copied code 22 from new code 21. Copied code 22 calls the original code 20 to perform the actual logic allocation (e.g., memory allocation and/or CPU allocation). Copied code 22 only calls original code 20 and it does not contain a copy of original code 20. This is required in order to avoid storing the original code 20, twice because this might be comparatively large. After calling original code 20, copied code 22 returns to new code 21. At that point, new code 21 verifies that the result of the performed allocation and its related activities were successful. After new code 21 completes verification, the result of the allocated activity is returned to the program that called the code in original code 20.

According to a preferred embodiment of the invention, implementation of the limitation of resources consumed from the computerized system on the memory address space is as follows:

If the call for utilizing resources is not according to the account of a specific consumer, then a call is made to the original code 20. The identification of an account may be obtained by employing several parameters, such as a user ID, group ID, program name, etc.

If the call for consuming resources is by account, this ensures that by allocating the memory, the account will not exceed its quota, or the quota of the level above it, etc. If an account exceeds its quota, then the executed command may fail in its operation.

Checking the result of the operation, whenever it succeeds, updating required information about that specific account (and the levels above it).

According to another preferred embodiment of the invention, the original code 20 is replaced with a new code. Preferably, but not limitatively, the new code includes some of the original code. Such an implementation comprises the steps of: allocating memory for the new code; and replacing the beginning of the original code with a “jump” operation to a new code. Preferably, the new code shall end with a “return” operation, for ignoring the original code completely.

The decision which implementation to use is left to the implementer, and the decision is made according to variety of parameters, such as the sizes of the original and new code, the difference between them, personal preferences etc.

According to a preferred embodiment of the invention, in order to make correct limitation memory consumption, all the stages that were described hereinabove should be performed without performing any “context switch” in the middle. The term “context switch” refers to the stage when the OS stops running one process, and continues executing another. Later on it would return to the halted process and continue it, etc. Otherwise, two processes of the same account might perform the calculation simultaneously, and reach the conclusion that the allocation is legal, although that is not so for both of them. For example, in Linux, the code in the kernel is executed in a single threaded environment, with no context switches.

When a new process is created, it might inherit the same pages as the process which created it, and then start modifying them for its own use. According to a preferred embodiment of the invention, such a case is handled by intercepting additional system calls (e.g., like “fork”, “exec”, etc. in UNIX), and adding or reducing the used memory according to indicators (i.e., flags) passed on to the command.

For example, Linux enables changing a page retrieved for read only, to be accessed as read/write. This operation can be performed using the suitable system call. Therefore, an application can use more pages on the swap space than it actually requested.

The actual swap allocation is carried out when specific pages are modified. Therefore, a program can request that one hundred pages be available for changing, but modify only two of them. The result is that only two pages are retained in the swap address space, while the others are retrieved from their original place. Typically, a program should not run out of memory address space while performing a legal command, and therefore it is assumed that the program will use all the pages it requests. Performing swap allocation is similar to allocating memory, as was described hereinabove.

Although predecessor level node can over-allocate a resource, the actual usage of all its successor nodes cannot exceed the predecessor's quota.

According to the preferred embodiment of the present invention, a relatively quick calculation of the resource's usage is obtained by using a tree form representing the account's hierarchy in the kernel memory address space. For each account, both its current allocation and its quota are retained in the kernel memory address space. Therefore, when a request for allocation is performed, the current allocation plus the requested memory is compared to the account's quota, and if it does not exceed its resources, then the same comparison is done for the levels above that account.

According to a preferred embodiment of the invention, the following described account's hierarchy enables managing a relatively large number of “accounts” without dealing with each account independently.

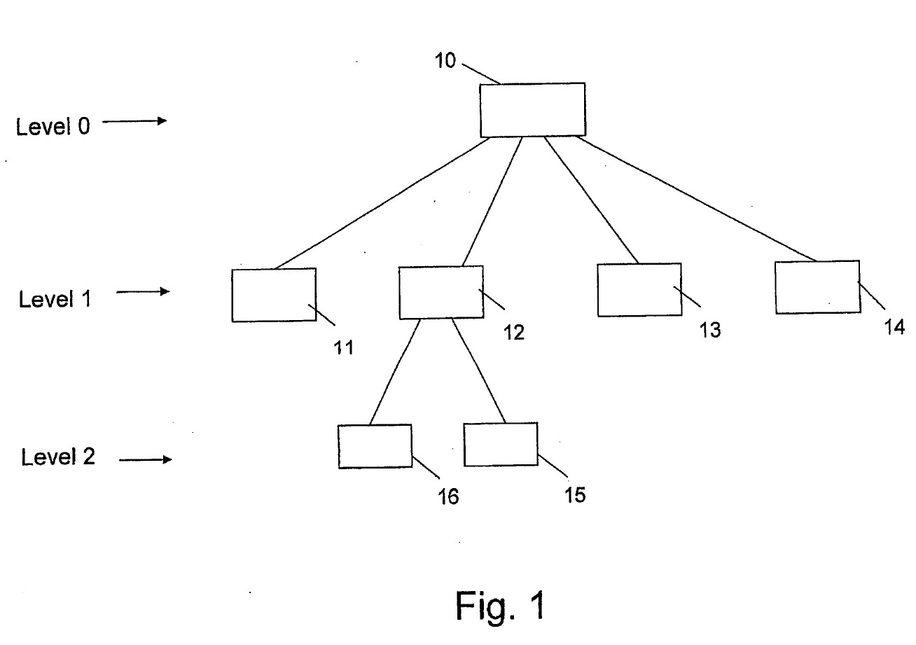

FIG. 1 schematically illustrates the hierarchical allocation of resources in a computerized system with multiple consumers, according to a preferred embodiment of the invention. Block 10 represents the total resources (i.e., 100%) of a computerized system. Blocks (i.e., nodes of the computerized system) 11 to 14 represent the allocated resources (in percentage) of each consumer of the computerized system. The relevant resource, e.g., memory, CPU, etc., is divided into hierarchical tree form, in such a way that each level (e.g., level 0, level 1 and level 2) serves as the 100 % quota to the levels underneath it. For example, the resources allocated to the consumer represented by block 12 in level 1 may be 20% of the total resources of the computerized system. However, the 20% of the resources allocated to block 12 are 100% of the resources granted to blocks 16 and 15 in level 2. According to another preferred embodiment of the present invention, the resources are allocated as a constant value, and not as a percentage of the resource. The conversion from one embodiment to the other is trivial to a skilled person in the art. Preferably, for easy calculation, the value that is used by the algorithm might be the absolute value, thus reducing the cost of the comparison operations.

At each level, each block (i.e., node) can either have a constant quota of the system's resources, or comprise a part of a specific “group”. Each group's quota is defined relative to other groups. For example, the computerized system may have three groups of consumers (i.e., blocks 11 to 13), so defined that each member of group 12 receives twice as many of the resources as a member of group 11, and a member of group 13 receives twice as many as those of the second one.

According to a preferred embodiment of the invention, there are two types of groups, resellers and non-resellers, wherein each type is directed to a different kind of use. For the resellers type, 100% of resources can be divided between several resellers, wherein each reseller can divide his allocated share to other resellers (or users), while it is possible to assign for these allocated shares, an “overselling” of the resources at a specific level, while not influencing the consumed resources of the levels above it. The non-resellers type can be used only at a specific level. Take the example where there are three groups, and each is weighted differently—simple, medium, and large. It is not desirable to guarantee a specific quantity of resources. It is preferable, to define the relation between the three groups. In this case, accounts can be added to each group, and the calculation of the resources for each account would be according to the total accounts and their assigned kind. If the values, for example, are 1, 2, and 4, respectively, then:
simple*1*X+medium*2*X+large*4*X=100%, i.

According to that formula the parameter X can be found, and from this the allocated resources for each group is obtained. Whenever an additional account is added, the parameter X is recalculated and each kind of account can be updated accordingly. This is easier than asking the user to perform this calculation and update each account accordingly.

The diagram refers to the reseller case. The groups aspect might be indicated by several accounts under 100%, with each account having an indication of its kind.

Assuming that the Data Center 16 allocates 30% of the system's resources to one client, and there is only a single member in each of the groups 11 to 13 (i.e., there are totally 4 accounts of consumers in level 1), and if we say that the members of group 11 get X %, then the total amount is:
30+X+2X+4X=100%

Therefore, members of group 11 receive 10%, members of group 12 receive 20%, and members of group 13 receive 40%.

According to this preferred embodiment of the present invention, additional accounts (i.e., consumers) can be added, and the calculated resources updated automatically according to predefined parameters such as the weights between the groups, as described hereinabove. Furthermore, it enables several hierarchical levels. For example, if a member of group 12 wishes to share his allocated resources between two sub-accounts 14 and 15, each member of the two sub-accounts 14 and 15 may have 10% of the total system resources. Each sub-account 14 and 15 may have half (50%) of the 20% from the allocated resources from group 12 in the level above them.

Additionally, the resources owner (at each level) can “oversell”, i.e., sell more than 100% of his allocated resources, by assuming that there will not be a case in which all the accounts he manages will exploit all their allocated share. However, the computerized system may prevent a situation in which the exploited resources exceed 100% of the relevant level. For example, if there are two accounts, each with 50% and one of them has two sub-accounts, each allocated 60% of his resources, then neither sub-account can exceed 30%. However, if all the accounts are active, the two sub-accounts together cannot exceed 50%.

Of course, the percentage notation is used for easy management by the human operator. The values within the algorithm are saved as absolute values.

The resources owner, for example, can decide whether to allow oversell, and by how much it may be exceeded. However, in case there is overselling, according to this example, it is the owner's responsibility to handle the legal aspects, as he might not be able to be held to the guaranteed resources.

The following describes a mechanism for limiting the CPU consumption of a specific account in the computerized system. The limiting of the CPU consumption is obtained by locating a required procedure in the code of the kernel, and then modifying it into a suitable code, as described hereinabove.

According to a preferred embodiment of the invention, the CPU usage is divided between the tasks requested from each account. The dividing of the task is based on scheduling the process that has to be performed by the CPU. The scheduling is controlled by the OS. For the sake of clarity, the process scheduling will be described with reference to Linux OS. However, the principle of the process scheduling is similar to other OSs. (Operating Systems).

In Linux, every process that has to be performed gets the following values: A scheduling policy, a priority in the scheduling group and a “nice” value.

Currently, the following three scheduling policies are supported under Linux: First-In-First-Out scheduling (SCHED_FIFO), Round Robin scheduling (SCHED_RR) and the default Linux time-sharing scheduling (SCHED_OTHER). Their respective semantics are described hereinbelow.

The following description of the scheduling in Linux OS is an essential background for better understanding the mechanism of limiting the CPU consumption that will be described afterwards.

The scheduler is the kernel part that decides which runnable process will be executed by the CPU next. The Linux scheduler offers three different scheduling policies, one for normal processes and two for real-time applications. A static priority value sched_priority is assigned to each process and this value can be changed only via system calls. Conceptually, for each process, the kernel maintains its value of dynamic priority, which equals to the static priority for real time processes, and is derived from the static priority and from the actual CPU usage for time sharing process (normal processes). In order to determine the process that runs next, the Linux scheduler looks for the non-empty list with the highest dynamic priority and takes the process at the head of this list. The scheduling policy determines for each process, where it will be inserted into the list of processes with equal static priority and how it will move inside this list.

According to Linux, SCHED_OTHER is the default universal time-sharing scheduler policy used by most processes, wherein SCHED_FIFO and SCHED_RR are intended for special time-critical applications that need precise control over the way in which runnable processes are selected for execution. Processes scheduled with SCHED_OTHER must be assigned the static priority 0, processes scheduled under SCHED_FIFO or SCHED_RR can have a static priority in the range 1 to 99.

Only processes with specific privileges can get a static priority higher than 0 and can therefore be scheduled under SCHED_FIFO or SCHED_RR. The system calls sched_get_priority_min and sched_get_priority_max can be used to find out the valid priority range for a scheduling policy in a portable way on all Portable OS Interface that based on Unix (POSIX) conforming systems.

All scheduling is preemptive: If a process with a higher static priority gets ready to run, the current process will be preempted and returned into its wait list. The scheduling policy only determines the ordering within the list of runnable processes with equal static priority.

SCHED_FIFO can only be used with static priorities higher than 0, which means that when a SCHED_FIFO processes becomes runnable, it will always preempt immediately any currently running normal SCHED_OTHER process. SCHED_FIFO is a simple scheduling algorithm without time slicing. For processes scheduled under the SCHED_FIFO policy, the following rules are applied: A SCHED_FIFO process that has been preempted by another process of higher priority will stay at the head of the list for its priority and will resume execution as soon as all processes of higher priority are blocked again. When a SCHED_FIFO process becomes runnable, it will be inserted at the end of the list for its priority. A call to sched_setscheduler or sched_setparam will put the SCHED_FIFO process identified by pid at the end of the list if it was runnable. A process calling sched_yield will be put at the end of the list. No other events will move a process scheduled under the SCHED_FIFO policy in the wait list of runnable processes with equal static priority. A SCHED_FIFO process runs until it is blocked by an I/O request, or it is preempted by a higher priority process, or it calls sched_yield.

SCHED_RR is a simple enhancement of SCHED_FIFO. Everything described above for SCHED_FIFO also applies to SCHED_RR, except that each process is only allowed to run for a maximum time quantum. If a SCHED_RR process has been running for a time period equal to or longer than the time quantum, it will be put at the end of the list for its priority. A SCHED_RR process that has been preempted by a higher priority process and subsequently resumes execution as a running process will complete the unexpired portion of its round robin time quantum. The length of the time quantum can be retrieved by sched_rr_get_interval.

SCHED_OTHER can only be used at static priority 0. SCHED_OTHER is the standard Linux time-sharing scheduler that is intended for all processes that do not require special static priority real-time mechanisms. The process to run is chosen from the static priority 0 list based on a dynamic priority that is determined only inside this list. The dynamic priority is based on the “nice” level (set by the “nice” or by a system call for set the priority) and increased for each time quantum the process is ready to run, but denied to run by the scheduler. This ensures fair progress among all SCHED_OTHER processes.

Typically, user's processes are based on schedule default type. Therefore, limiting the CPU consumption of a specific account in the present invention refers only to tasks that are based on schedule default type.

Regarding the tasks that are from schedule default type, the Linux scheduler works in the following way:

When there is a need (as described hereinbelow)—it goes over all the tasks that are candidates for being run, and allocates a “counter” for each one. This “counter” holds the number of “ticks” that this task might be run. The calculation is made in such a way, that the “ticks” that a task would get are relative to its “nice” value (including the effect of whether the task was run in the last time quantum or not).

Every “tick” (which is 1/100 of a second, usually), the scheduler checks which task are the current one, and decreases one from its counter. If the counter reaches “0”, this task has finished its quota for the current quantum, and another task should be executed. The selection as to which task to select is based on the value of the “counter” of the tasks, and the task with the largest “counter” shall be selected. It is important to mention that only tasks that are in a state of “running” are candidates for selection, as processes in other states are waiting for something and therefore can not use the CPU even if they get it.

If there is no task with a positive counter that can be run, a new time quantum is started and the “counter” is calculated again for all the tasks.

A task can reach a stage where it can not use the CPU anymore. For example—when the task tries to access a file on the disk. In that case, the task gives up the CPU, and asks the scheduler to select the next task to be executed. Note that in most cases, a program has many places where it is in a “wait” state, and actually spends most of its time in that state.

According to the preferred embodiment of the invention, the calculation of the “counter” is modified, so that each task would be limited by the quota of the account that it is part of. Modifying the calculation of the counter requires interfering in the operation of the OS as follows:

Holding the correct value of the counter according to the quotas when its value is calculated.

Whenever a decision is made about the next task to run, confirm that the selection of the next task to run is valid. This option is essential, as in some cases, tasks should be granted less CPU (due to the fact that the other tasks of the same account consumed more than their share) or more CPU (if all the other tasks of the account did not ask for any).

According to the preferred embodiment of the invention, the modification of the counter calculation is done as follows:

Intercepting the function that performs the calculation of the “counters”.

Calculating the desired “counter” value for each task, based on the guaranteed value to the user account. If there are several tasks that belong to the same account—their sum would be calculated according to the account, while their internal allocation is according to their use so far. For every process, keeping information regarding its “behavior”, and especially if it is mainly a CPU task or an IO task. An application that is mainly IO would not use the CPU for the entire tick anyway, so it should get higher priority than a CPU-oriented task (otherwise—the accumulated time that it would get would be less than it deserves). According to another preferred embodiment of the invention, the CPU resource can be divided between all the tasks evenly. The calculation of the counter value is performed in such a way, that when the Linux OS applies its algorithm on the tasks, it would get the values that were calculated according to the present invention.

On every “tick”, the amount of CPU resource that the account received during the last time is calculated (see below), and adds it to the levels above this account as well. If the account (or a level above it) got more than its share—the “counter” of the task decreases to zero, thus preventing it from getting any further CPU, until the next CPU allocation is done. This operation is performed only if there are other tasks that can use the CPU, as otherwise a loop of allocating CPU to this task only is obtained, preventing it from using it, etc.

The following describes the method of calculating the CPU usage, according to the preferred embodiment of the invention. In order to enhance the calculation method, apart from the simplicity of the calculation function, the following guidelines are also provided:

Only the status in some constant time period is taken into consideration, in order to prevent an account that has been idle for a long time, from getting a lot of CPU (i.e., to compensate for the time it was idle). For example, if an account deserves 50% of the CPU, and it has been idle for an hour, in the following hour, it would not be fair for it to get the entire CPU (if other tasks need it as well). It should get only 50% of that hour, and this 50% should be spread across the hour.

An “aging” mechanism is required, so that the account that had the CPU for 1 “tick” in the last 1 second, will be treated differently than an account that had the CPU for 1 “tick” in the last 5 seconds.

According to the preferred embodiment of the invention, the information regarding which task is being executed is obtained and then calculated only when a computer “tick” occurs. It might have been that more than one task used the CPU during the elapsed “tick”, but usually this is not the case. There could be a switch between tasks if, for example, a task that already started running, has asked for information from the disk, which stops the disk from running, and then the CPU was allocated to another task for the rest of the “tick”. According to another embodiment, the calculation is performed at a sub-tick level, after intercepting the function that switches between the tasks. However, this situation is relatively rare, and therefore we can ignore it in our calculations.

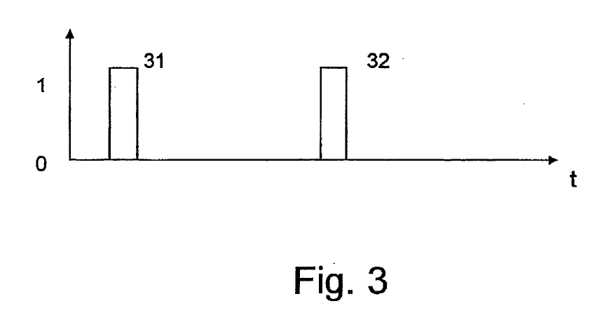

The CPU consumption is calculated with a set of mathematical functions having a value of either 0 or 1 at each “tick” according to whether the account used the CPU resources at that time, or not. Please note that all the calculations could be done using any time-base, other than “ticks”. The term “ticks” is used only for clarification. For the sake of the explanation, it is assumed that there are “N” accounts which are at the same level (i.e., there are no hierarchies). The calculation for the case of several levels is similar. The utilization function which provides the CPU usage by a specific account is shown in FIG. 3, wherein the account used the CPU resources for limited periods of time only (i.e., only when the value of the function is equal to 1, represented by items 31 and 32), instead of using it the entire period along the t axis.

According to the preferred embodiment of the invention, the function that is used for calculating the aging factor is non-linear and it weights the time that a specific account “i” receives the CPU, based on the elapsed time since then. Therefore the aging function is:

$${f}_{i} ( x ) = \frac{1}{τ} {ⅇ}^{- \frac{t}{τ}}$$

The utilization function of the specific account “i” takes into consideration the “aging” factor and as a result it provides the usage of the CPU for specific account “i” at time t. The utilization function is:

$${U}_{i} ( t ) = {\int }_{0}^{t} \frac{1}{τ} {ⅇ}^{- \frac{x}{τ}} {Usage}_{i} ( t - x ) ⅆ x$$

The following parameter “Ri” defines the consumed resources for the specific account “i”. “Ri” is an iterative value, that is updated every “tick”. This parameter receives the aging effect, therefore for account “j”, which is currently the active account

$${R}_{j}^{new} = \frac{{R}_{j}^{old} + Δ}{1 + Δ}$$

and for the specific account “i” (i≠j):

$${R}_{i}^{new} = \frac{{R}_{i}^{old}}{1 + Δ}$$

As can be seen, this parameter has the following characteristics:
The sum is always 1.
It has an “aging” effect.

However, the above calculation would require updating the information about all the accounts on every “tick” (which might be a lot, if there are hundreds or even thousands of accounts). Therefore, according to the preferred embodiment of the invention, the number of operations performed by this calculation is reduced by defining a new value named “C” that is multiplied by (1+Δ) on every “tick”:
C^{New}=(1+Δ)C^{old}
wherein “C” is the denominator of all the values, for all the numbers. Therefore, instead of calculating Ri, the value Ri×C is calculated. As a result there is only a need to modify “C” and Rj, and not all the Ri.

This new value is kept in the kernel's memory. Thus, only the “R” of the modified account “i” has to be updated:
Rᵢ^{new}=(1+Δ)Rᵢ^{old}

The actual resource consumption for account “k” (“k” can be “i” as well) is:

$$\frac{{R}_{k}}{C}$$

Please note that the calculation takes into account overflow and underflow effects (as each value of “C” grow all the time, and the ratio can be very small).

Whenever the calculation is performed, the consumption rate of the account, and the levels above it are being checked. If any of them passes the guaranteed value, then the task does not get any more resources until the next resources-allocation by the scheduler.

As described hereinabove, the scheduling algorithm decides on the amount of “ticks” that each task would get, based on its “nice” value. However, the nice value has only a specific number of levels (e.g., 40 levels), and therefore the maximal ratio between the task that should get the most CPU usage and the least can only be 40. But, assuming that there are three accounts, one that should get 90% of the CPU, and runs only 1 task, and 2 other tasks that get the rest (10%, or 5% each) and that run 5 tasks each. In this case the ratio is 1:90, and it can not be handled by the default calculation of the Linux.

According to another embodiment of the invention, it performs the high-level calculation external to the “nice” values, and when the Linux is performing the scheduling—takes into consideration only some of the accounts and drops the rest. For example, in the case mentioned above, in a one schedule cycle—have one small account get the entire 10%, and on the next—give it to the other. The same mechanism applies to the tasks within the account, so that only some of the accounts run each time. This is a static solution that might not get the guaranteed resources, as the tasks that might be selected will not consume the entire allocated resources.

According to a preferred embodiment of the present invention, it modifies the scheduler, so that whenever a new scheduling cycle is done, it would grant some “ticks” to the “less than 1” tasks. The number of “ticks” that they would receive are given according to their cumulative weight. This solution is a dynamic one, and grants these tasks their share.

For every task, an additional value is kept, which is the cumulative weight, and the scheduler knows the number of ticks that it should allocate to the “less than 1 tick” in the current allocation. Whenever a task selection is performed, the scheduler checks if there is still enough time for the “less than 1 tick” tasks, and if there is, it would select one of them (based on its weight) and execute it.

The above examples and description have of course been provided only for the purpose of illustration, and are not intended to limit the invention in any way. As will be appreciated by the skilled person, the invention can be carried out in a great variety of ways, employing more than one technique from those described above, such as allowing a consumer to monitor the resource allocation policy before it is implemented,, all without exceeding the scope of the invention.

1. A method for dynamically allocating and managing resources in a computerized system managed by an operating system (OS) and having multiple accounts of consumers, comprising:
a) allocating, in a swap file, portions of the virtual memory address space for each account associated with a consumer;
b) limiting the memory address space for each account;
c) dividing the CPU usage between the tasks requested from each account; and
d) changing segments in the original code of said OS by locating one or more specific procedures in said original code, and modifying said specific procedures to operate according to the allocation and/or the limitation of said memory address space and/or the limitation of the number of processes and/or the divided CPU usage.

2. A method according to claim 1, further comprising dynamically modifying the specific procedures to operate in response to varying allocation and/or limitation of the memory address space and/or the divided CPU usage.

3. A method according to claim 1, wherein locating the required procedure comprises obtaining the name of said required procedure that is stored in a symbol table.

4. A method according to claim 1, wherein locating the required procedure is carried out by identifying a sequence of bytes of said required procedure.

5. A method according to claim 1, wherein the modification of a specific procedure comprises:
a) obtaining the allocated memory address space;
b) creating an executable code in said allocated memory address space;
c) copying code segments from the original code;
d) saving the commands line at the beginning of said copied code, and skipping to the beginning of the next command in said original code; and
e) replacing the commands line at the beginning of said original code by skipping to the beginning of said created application, and adding non-operational bytes to the unused bytes of said created application.

6. A method according to claim 4, wherein the blank bytes are No Operations (NOPs) data.

7. A method according to claim 1, wherein the limitation of the memory address space is implemented by performing the following steps:
a) calling the original code whenever the call for consuming resources is not by an account of a specific consumer, and identifying said account by its related parameters;
b) verifying that said account will not exceed its quota, or the quota of the level above it according to said allocated memory address space, whenever resource consumption is required by an account;
c) checking the result of an operation related to said account, whenever it succeeds, updating the consumption data of said account and/or of the levels above said account.

8. A method according to claim 7, wherein the identifying parameters are a user ID, group ID or program name.

9. A method according to claim 1, wherein the limitation of the memory address space is implemented by replacing the original code with a new code, which comprising the steps of:
a) allocating memory for the new code; and
b) replacing the beginning of the original code with a “jump” operation to a new code.

10. A method according to claim 9, wherein the new code ends with a “return” operation, for ignoring the original code completely.

11. A method according to claim 9, wherein the new code includes partial operations of the original code.

12. A method according to claim 1, further comprising dynamically allocating CPU resources that are not used by tasks to other tasks.

13. A method according to claim 1, wherein the CPU usage is divided between all the tasks uniformly.

14. A method according to claim 1, wherein the division of the CPU usage between the tasks is obtained by modifying the calculation of the “counter” of the tasks that are candidates for being executed, so that each task is limited by the quota of the account that is associated with said tasks.

15. A method according to claim 14, wherein the modification of the counter calculation, comprises:
a) Intercepting the function that performs the calculation of the “counters”;
b) Calculating the desired “counter” value for each task, based on the guaranteed value to the user account and holding the correct value of the counter according to the quotas when its value is calculated whenever there are several tasks that belong to the same account, summing the “counter” value of said tasks according to the account, while their internal allocation is currently according to their usage;
c) keeping information regarding the “behavior” of each process;
d) calculating on every “tick” the amount of CPU resource that the account received during the last time, and adding said calculated amount to the levels above said account;
e) whenever said account or a level above said account receives more than its allocated share, the “counter” of the task is decreased to zero, until the next CPU allocation is done; and
f) Whenever a decision is made about the next task to be executed, confirming that the selection of the next task to be executed is valid.

16. A method for dynamically allocating and managing resources in a computerized system having multiple consumer accounts, substantially as described and illustrated.
